(19) United States
(12) Patent Application Publication
(10) Pub. No.: US 2005/0091855 A1
(43) Pub. Date: May 5, 2005

(54) Method and apparatus for making a razor safe

(76) Inventor: Michelle A. Hannan, Worcester, MA (US)

Correspondence Address: EVELYN M. MARSHALL, ESQUIRE, 679 PLEASANT STREET, PAXTON, MA, 01612, US

(21) Appl. No.: 10/980,023

(22) Filed: Nov. 3, 2004

Related U.S. Application Data
(60) Provisional application No. 60/516,846, filed on Nov. 3, 2003.

(51) Int. Cl. B26B 19/02

(52) U.S. Cl. 30/346.5; 30/346.55

(57) ABSTRACT

The present invention provides persons in charge of the care of other individuals with a tool for shaving that is designed to be safer to individuals in institutionalized environments, due to a shallow razor blade with rounded corners that is encased in a durable material.

### CROSS-REFERENCE TO RELATED APPLICATIONS

This application is copending with provisional application Ser. No. 60/516846, filed Nov. 3, 2003. I incorporate said provisional application by reference as fully set forth.

### STATEMENT REGARDING FEDERALLY SPONSORED RESEARCH AND DEVELOPMENT

This invention has been created without the sponsorship or funding of any federally sponsored research or development program.

### REFERENCE TO A “MICROFICHE APPENDIX”

Not Applicable

### BACKGROUND OF THE INVENTION

1. Field of the Invention

The present invention relates generally to shaving devices, and more specifically to an apparatus and method for enclosing a razor blade to make it safe.

2. Prior Art

Razors and razor blades have been developed, inter alia, to remove hair from the human body, typically on the face, legs and under arms, although, hair removal may be desired from other parts of the body. Said razors and razor blades have been refined over the years to ensure the closest shave possible while minimizing the chances of cutting the skin. Said razor typically includes a razor blade or razor blades that are fixedly encased in a durable material for multi-time use. Said fixedly encased razor blade(s) are typically releasably connected to a handle base for a multi-use handle or fixedly encased in an all in one unit for a one-time use handle. Said one-time use razors are typically lower in quality and cost, are considered disposable, and are therefore generally supplied at low or no cost to individuals in hotels, hospitals, prisons and the like.

Although said razors and razor blades have been developed to minimize the chances of cutting the skin, they are not specifically designed to be safe. More specifically, the razors have not been constructed to prevent an individual from taking the razor apart to use the enclosed razor blades as a weapon to harm others or a tool to harm themselves.

Therefore, existing razors have drawbacks in environments where personal safety is an issue.

Firstly, the one-time use razors can be quickly and easily taken apart allowing an institutionalized person to hide the fixedly encased razor blade and later adapt it for their desired use, usually to harm themselves or someone else.

Secondly, the razor depth is such that if said fixedly encased razor blade is used to harm oneself or someone else, severe bodily harm typically results.

Thirdly, the razor blade design is such that if said razor blade is taken internally, severe bodily harm typically results.

There is therefore a need in the art for a razor that is constructed of durable material with a reduced blade depth and rounded blade corners, such that the distrubutee would consider it a safer alternative to the aforementioned one-time use razors.

It is therefore a principal object of the present invention to provide a durably encased razor blade that cannot be easily or quickly taken apart, said razor blade having rounded corners and a shallow razor depth, which will minimize bodily injury when an individual uses it as a weapon or a tool to harm themselves or someone else.

A further object of the present invention is to provide a safe razor that is effective in removing hair from the skin.

A further object of the present invention is to provide a safe razor that is simple in design.

A further object of the present invention is to provide a safe razor that is inexpensive, and therefore disposable.

With these and other objects in view, as will be apparent to those skilled in the art, the invention resides in the combination of parts set forth in the specification and covered by the claims appended hereto.

### BRIEF SUMMARY OF THE INVENTION

A novel approach to making razors safe has now been discovered, thus providing the distrubutee and user with a safer razor. The present invention achieves a safer way of unsupervised razor use for individuals and, more specifically, institutionalized individuals. By using the disclosed invention, the distrubutee and user will now enjoy a safer razor with rounded corners and a shallow blade. The primary advantage of using the present invention is that less bodily injury is likely to occur to individuals who come in contact with said safe razor. The present invention will hereinafter be referred to as the Safe Razor.

These and other objects will be apparent to those skilled in the art, along with advantages and features of the invention disclosed herein, will be made more apparent from the description, drawings and claims that follow.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIG. 1A is a front perspective view of an embodiment of the razor blade of the present invention;

FIG. 1B is a top perspective view of an embodiment of the razor blade of the present invention;

FIG. 1C is a side perspective view of an embodiment of the razor blade of the present invention;

FIG. 1D is an end perspective view of an embodiment of the razor blade of the present invention;

FIG. 1E is an enlarged end perspective view of an embodiment of the razor blade of the present invention;

FIG. 2A is a top perspective view of an embodiment of the razor blade enclosure of the present invention;

FIG. 2B is a side perspective view of an embodiment of the razor blade enclosure of the present invention;

FIG. 2C is an end perspective view of an embodiment of the razor blade enclosure of the present invention;

FIG. 2D is an expanded end perspective view of an embodiment of the enclosed razor blade of the present invention;

FIG. 2E′ is a top left perspective view of an embodiment of the enclosed razor blade of the present invention;

FIG. 2E″ is a top right perspective view of an embodiment of the enclosed razor blade of the present invention;

FIG. 3A is a back perspective view of an embodiment of the safe razor of the present invention;

FIG. 3B is a front perspective view of an embodiment of the safe razor of the present invention;

FIG. 3C is a side perspective view of an embodiment of the safe razor of the present invention; and

FIG. 3D is a front right perspective view an embodiment of the safe razor of the present invention.

### NUMBERING OF THE DRAWINGS

2. Safe Razor
4. Connecting Means
6. Handle
8. Enclosed Razor Blade
10. Face Plate
12. Side Plate
14. Body
16. Semi Rectangular Opening
18. Safe Razor Blade
20. Blade Portion
22. Base Portion

### DETAILED DESCRIPTION OF THE INVENTION

In the broadest aspects, the present invention provides the skilled artisan with the analytical tools and technical know-how sufficient to make and use the disclosed invention. The present invention provides persons in charge of the care of other individuals with a tool for shaving that is designed to be safer to individuals in institutionalized environments, due to a shallow razor blade with rounded corners that is encased in a durable material.

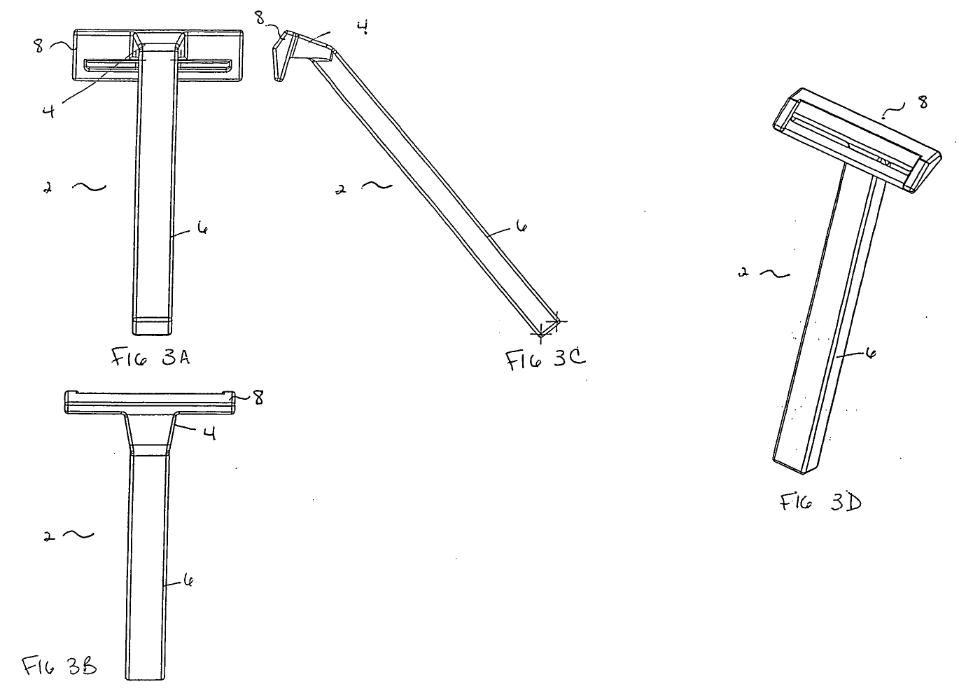

Referring first to FIGS. 3A through 3D, wherein like elements are indicated by like numerals, an embodiment of the present invention, in its most basic form, is generally indicated by the reference numeral 2, and comprises a handle, generally indicated by reference numeral 6, a connecting means, generally indicated by reference numeral 4, and an enclosed razor blade, generally indicated by reference numeral 8. The Safe Razor 2 is shown in functional form.

In further detail, said handle 6 is of the type commonly used on most disposable razors and is connected to said enclosed razor blade 8 by said connecting means 4. Said handle 6 is made out of a rigid material such as high density polyurethane, polystyrene or any inexpensive rigid material such as casted metals, reinforced nylon or other non-brittle durable material known by one of ordinary skill in the art to be effective for this purpose. Other equivalent substances would also be suitable. Identification of equivalents is well within the skill of the ordinary practitioner and would require no more than routine experimentation.

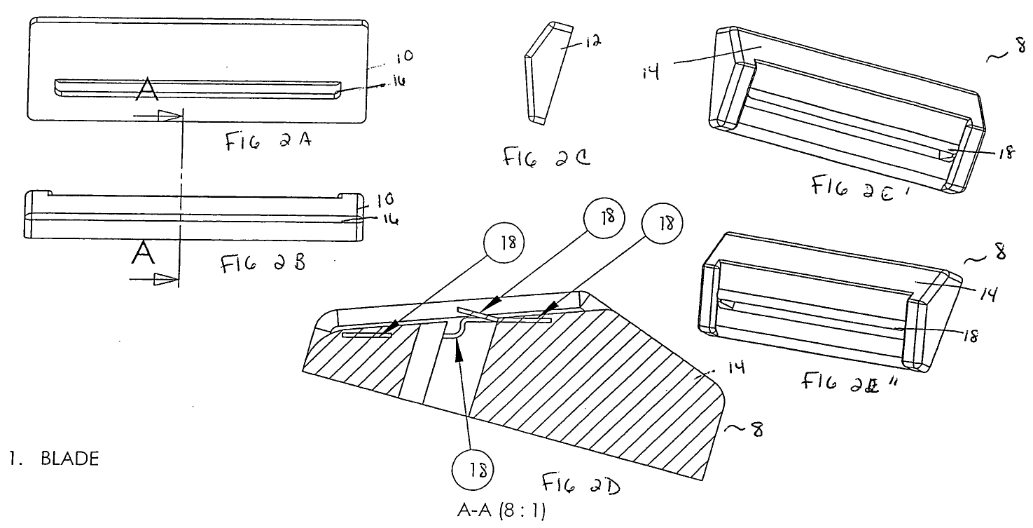

Referring to FIGS. 2A through 2E″, where like elements are indicated by like numerals, said enclosed razor blade 8 is comprised of a face plate 10, a side plates 12 and a body 14. Said face plate 10, in the present embodiment, is in the shape of a rectangle with a semi rectangular opening 16 for safe razor blade 18. Said side plates 12, in the present embodiment, are pentagonal in shape as shown in FIG. 2C. Said body 14, in the present embodiment is of the shape disclosed in FIGS. 2C, 2D, 2E′ and 2E″. The shape of said face plate 10, said side plates 12, and body 14 are based on standard disposable razor blades presently on the market. Said shape of said face plate 10, said side plates 12, and said body 14 do not encompass all embodiments contemplated by the inventor and thus are not limited to those enumerated above. Said face plate 10, side plates 12 and body 14 are well known to those of ordinary skill in the art and may vary in shape and size to accommodate the encapsulation of said safe razor blade 18. Said face plate 10, said side plates 12 and said body 14 are made out of a flexible, durable material with impact resistant properties such as Polyethylene Tetraflorethelene (PETFE), Fluorinated Ethylene Propylene (FEPE), low density polyethylene or a durable material such as casted metals, reinforced nylon or other non-brittle durable material known by one of ordinary skill in the art to be effective for this purpose. Other equivalent substances would also be suitable. Identification of equivalents is well within the skill of the ordinary practitioner and would require no more than routine experimentation.

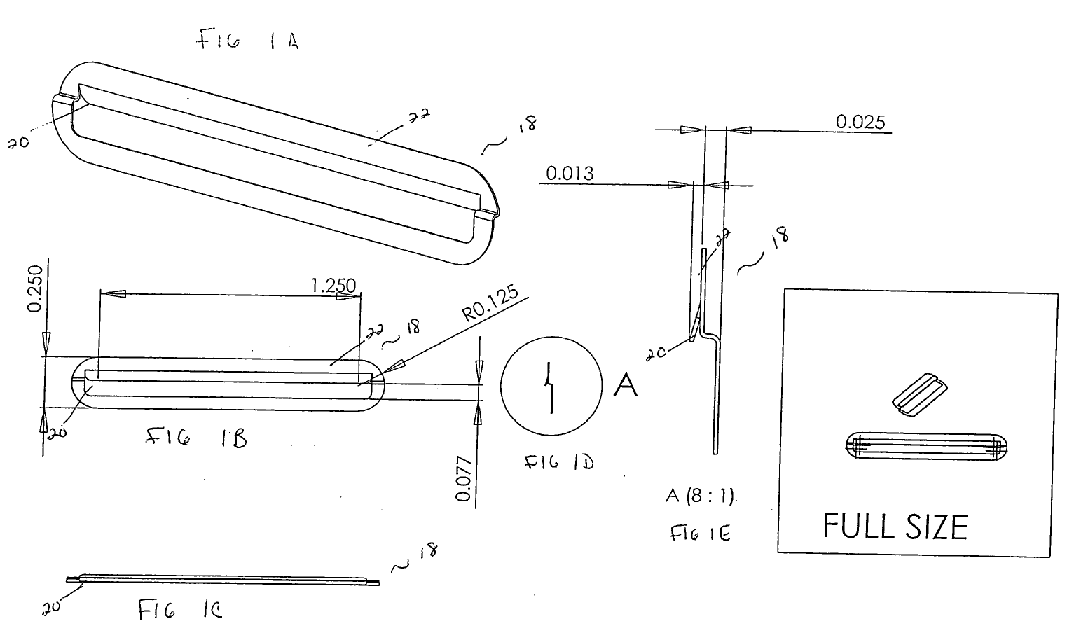

Referring to FIGS. 1A through 1E, where like elements are indicated by like numerals, said enclosed safe razor blade 18 is comprised of a razor portion 20 and a base portion 22. Said razor portion 20 and said base portion 22 make up one unit and are mass produced as a prefabricated metal product. The resultant shape of said base portion 22, in the present embodiment, is in the shape of an elongated oval with a semi-rectangular opening 24 running the length of said elongated opening. The bottom portion of said base portion 22 is bent at a 90 degree angle in the opposite direction from said razor at the midway point of said elongated oval and bent again at a 90 degree angle at a distance from the first bend to create a duel level plate. See FIG. 1B. Said razor portion 20 protrudes from the upper portion of the semi-rectangular opening 24. Said razor portion has rounded corners and a reduced razor depth. Said safe razor blade 18 is made out of a durable material, such as ceramic, carbide, stainless steel, tool steel, M-2 High Speed Steel and/or similar to the blade material used in a standard razor blade, typically made of steel. Other equivalent substances would also be suitable. Identification of equivalents is well within the skill of the ordinary practitioner and would require no more than routine experimentation. In the preferred embodiment, said safe razor blade 18's functional edge will protrude from said base portion 22, leaving no sharp edges to cause any physical harm. Said protrusion will be of minimal distance to still allow functional use of the safe razor blade 18. Said safe razor blasé 18 edges are preferably dull, by either folding over and/or encapsulating said safe razor blade 18 in a flexible, durable material with impact resistant properties and discussed above.

The invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims rather than by the foregoing description, and all changes which come within the meaning and range of equivalency of the claims are therefore intended to be embraced herein.

1-5. (canceled)

6. A razor blade wherein said razor blade comprises:
a. an inner section, wherein said inner section comprises at least one protruding functional edge; and
b. an outer section, wherein said outer section comprises the base portion of said razor blade, and wherein said inner portion and said base portion are united to form said razor blade.

7. The razor blade of claim 6, wherein said protruding functional edge(s) of said razor blade is/are just sharp enough to cut hair.

8. The razor blade of claim 6, wherein said protruding functional edge(s) protrude(s) a minimal distance from said base portion.

9. A safe razor comprising:
a. a razor blade; and
b. a razor blade enclosure wherein said razor blade is at least partially encapsulated in said razor blade enclosure, and wherein said razor blade enclosure is constructed of an impact resistant material.

10. The safe razor of claim 9, wherein said razor blade comprises:
a. an inner section, wherein said inner section comprises at least one protruding functional edge; and
b. an outer section, wherein said outer section comprises the base portion of said razor blade, and wherein said inner portion and said base portion are united to form said razor blade.

11. The safe razor of claim 9, wherein said protruding functional edge(s) of said razor blade is/are just sharp enough to cut hair.

12. The safe razor of claim 9, wherein said protruding functional edge(s) protrude(s) a minimal distance from said base portion.

13. The safe razor of claim 9, further comprising:
a. a razor blade handle; and
b. a connecting means to connect said razor blade enclosure to said razor blade handle.

14. The safe razor of claim 9, wherein said connecting means allows the razor blade enclosure to pivot along the angle of use.

15. A method of making a safe razor comprising the steps of:
a. Forming a razor base portion out of standard razor blade material;
b. Forming one or more protruding functional edges out of standard razor blade material;
c. Connecting said protruding functional edges to said base portion; and
d. Semi-encapsulating said connected protruding functional edges and said base portion base in an impact resistant material.

16. The method of claim 14, additionally comprising the step of connecting a handle to said semi-encapsulated base portion and protruding functional edges via standard connecting means.

17. The method of claim 14, wherein in said standard connecting means allows the semi-encapsulated base portion and protruding functional edges to pivot along the angle of use.
